(19) United States
(12) Patent Application Publication
(10) Pub. No.: US 2026/0319484 A1
(43) Pub. Date: Oct. 15, 2026

(54) Method for Checking a Control Value as Part of Controlling a Technical System

(71) Applicant: Robert Bosch GmbH, Stuttgart (DE)

(72) Inventor: Stefan Noe, Stuttgart (DE)

(21) Appl. No.: 19/643,014

(22) Filed: Apr. 9, 2026

(30) Foreign Application Priority Data
Apr. 11, 2025 (DE) 10 2025 114 322.6

(51) Int. Cl. G05B 23/02; G01B 11/02

(52) U.S. Cl. CPC G05B 23/0262; G01B 11/026

(57) ABSTRACT

A method for testing a control value as part of controlling a technical system includes (i) providing the control value by way of a first component of the technical system, (ii) calculating a first checksum based on the control value provided by the first component, (iii) transmitting the control value and the first checksum to a second component of the technical system, (iv) calculating a second checksum based on the control value transmitted by the first component, and (v) checking the control value based on a comparison of the first checksum with the second checksum by the second component. A laser distance measuring device, a computer program and a storage medium for this purpose are also disclosed.

This application claims priority under 35 U.S.C. § 119 to patent application no. DE 10 2025 114 322.6, filed on Apr. 11, 2025 in Germany, the disclosure of which is incorporated herein by reference in its entirety.

The disclosure relates to a method for checking a control value as part of controlling a technical system. The disclosure further relates to a laser distance measuring device, a computer program and a storage medium for this purpose.

### BACKGROUND

Digital or software controls may periodically read in and output digital values to close a loop over a control path. If the data is exchanged within a closed system, e.g. in a processor, they are largely protected against interference, and the error frequency can be estimated by way of MTTFd, i.e., a mean time to dangerous failure.

In the example of laser control in a laser distance measuring device, a processor measures and controls voltages with an integrated analog-to-digital converter and digital-to-analog converter. The control software runs in the processor.

A disadvantage of current system architectures is, in particular, the analog interfaces for the measured and actuating variables. During transmission via the interfaces, errors may occur that, in the worst case, could be converted unnoticed into dangerous control signals for a laser diode of the laser distance measuring device.

### SUMMARY

The subject matter of the disclosure is a method, a computer program, a laser distance measuring device, as well as a computer-readable storage medium with the features set forth below. Further features and details of the disclosure result from the description and the drawings. Features and details which are described in connection with the method according to the disclosure naturally also apply in connection with the computer program according to the disclosure, the laser distance measuring device according to the disclosure, as well as the computer-readable storage medium according to the disclosure, and vice versa in each case, so that a reciprocal reference is always possible with regard to the disclosure of the disclosure.

The subject of the disclosure is in particular a method for checking a control value as part of controlling a technical system comprising the following steps:
providing the control value by way of a first component, in particular a source of the control value, of the technical system (1),
calculating a first checksum based on the control value provided by the first component,
transmitting the control value and the first checksum to a second component, in particular a receiver of the control value, of the technical system (1),
calculating a second checksum based on the control value transmitted by the second component,
checking the control value based on a comparison of the first checksum with the second checksum by way of the second component.

Errors in the data transmission of the control value can thus be reliably detected, and the safe functioning of the technical system can be ensured. The use of two checksums, in particular, increases safety compared to individual calculations. This may contribute to the functional safety of the technical system and may minimize the risk of malfunctions that could lead to safety risks.

It is further conceivable that the technical system is a laser distance measuring device and comprises at least one software control loop and/or a hardware control loop, wherein a laser diode of the laser distance measuring device is controlled as part of controlling the software control loop and/or the hardware control loop.

Preferably, it may be provided that the software control loop comprises an analog-to-digital converter and a processor, in particular a microprocessor or microcontroller, wherein the first component is the analog-to-digital converter, and the second component is the processor, wherein the control value corresponds to a measured value of the laser diode. The software control loop may thus capture measured values and send corresponding control signals to the laser diode. The analog-to-digital converter and processor are preferably arranged in proximity to the laser diode. By integrating the analog-to-digital converter and processor near the laser diode, the response time of the laser distance measuring device can be improved, which can lead to higher accuracy and stability of control.

Optionally, it may be provided that the software control loop comprises a digital-to-analog converter and a (further) or the processor, wherein the first component is the processor, and the second component is the digital-to-analog converter, wherein the control value corresponds to an actuating value for the laser diode.

Alternatively, the method may further comprise the following steps:
providing an actuating value for the laser diode by way of the processor,
calculating a third checksum based on the actuating value by way of the processor,
transmitting the actuating value and the third checksum to the digital-to-analog converter,
calculating a fourth checksum based on the transmitted actuating value by way of the digital-to-analog converter,
checking the actuating value based on a comparison of the third checksum with the fourth checksum by way of the digital-to-analog converter.

Thus, advantageously, an additional increase in safety may be provided by the third and fourth checksums.

Furthermore, it may be provided within the scope of the disclosure that the hardware control loop comprises a processor, in particular a microprocessor or microcontroller, and an application-specific integrated circuit, wherein the first component is the processor, and the second component is the application-specific integrated circuit, wherein the control value corresponds to a target value for the laser diode.

Alternatively, the method may further comprise the following steps:
providing a target value for the laser diode by way of the processor,
calculating a fifth checksum based on the target value by way of the processor,
transmitting the target value and the fifth checksum to the application-specific integrated circuit,
calculating a sixth checksum based on the transmitted target value by way of the application-specific integrated circuit,
checking the target value based on a comparison of the fifth checksum with the sixth checksum by way of the application-specific integrated circuit.

Thus, advantageously, an additional increase in safety may be provided by the fifth and sixth checksums.

In a further embodiment, it may be provided that the method, if checking the control value indicates an inequality between the first checksum and the second checksum and/or checking the actuating value indicates an inequality between the third checksum and the fourth checksum and/or if checking the target value indicates an inequality between the fifth checksum and the sixth checksum, further comprises:
transitioning the technical system, preferably the laser diode of the laser distance measuring device, to a safe state, in particular to an off state.

In other words, transitioning to the safe state may mean that the laser diode is transitioned to an off state or a state, in which the laser power is non-hazardous to the human eye. This has the advantage that the technical system can react autonomously to detected errors and transition to a safe state. This can minimize the likelihood of damage to people or machinery or erroneous measurements.

It is additionally advantageous if, in the context of the disclosure, the method, if checking the control value indicates an inequality between the first checksum and the second checksum and/or checking the actuating value indicates an inequality between the third checksum and the fourth checksum and/or if checking the target value indicates an inequality between the fifth checksum and the sixth checksum, further comprises:
initiating an output, wherein the output indicates that there is an error in the technical system or the control of the technical system.

For example, the error may be an incorrectly transmitted value. For example, a measured value could be lost, or a digital value could be corrupted. It is thus possible for the technical system to output a warning message if an inequality between the checksums is determined. This can advantageously alert a user to the error in order to take appropriate measures, such as verifying and, if necessary, repairing or replacing components.

The subject of the disclosure is additionally a laser distance measuring device comprising a software control loop and/or a hardware control loop, wherein the laser distance measuring device is configured to perform the method according to the disclosure. Thus, the laser distance measuring device according to the disclosure has the same advantages as described in detail with respect to the method according to the disclosure. The laser distance measuring device, and/or the software control loop and/or the hardware control loop, may thereby comprise a data processing device that is configured to perform the method according to the disclosure. The device may be at least one computer, for example a microcomputer or processor or integrated circuit, that executes the computer program according to the disclosure. The computer may have at least one processor for executing the computer program. A non-volatile data memory can be provided as well, in which the computer program can be stored and from which the computer program can be read by the processor for execution.

Another object of the disclosure is a computer program, in particular a computer program product, comprising instructions which, when the computer program is executed by at least one computer, cause the computer to carry out the method according to the disclosure. The computer program according to the disclosure thus brings about the same advantages as have been described in detail with reference to the method according to the disclosure.

The disclosure can also relate to a computer-readable storage medium, which comprises the computer program according to the disclosure and/or commands that, when executed by at least one computer, prompt said computer program to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be executed as a computer-implemented method. Alternatively or additionally, at least one of the disclosed method steps may be computer-implemented and/or performed automatically.

### BRIEF DESCRIPTION OF THE DRAWINGS

Further advantages, features and details of the disclosure will be apparent from the following description, in which exemplary embodiments of the disclosure are described in detail with reference to the drawings. In this case, the features mentioned in the claims and in the description may in each case be essential to the disclosure individually or in any desired combination. It shows:

FIG. 1 a schematic illustration of a laser distance measurement device according to exemplary embodiments of the disclosure,

FIG. 2 a schematic illustration of a laser distance measurement device according to exemplary embodiments of the disclosure,

FIG. 3 a schematic visualization of a method, a device, a storage medium and a computer program according to exemplary embodiments of the disclosure.

### DETAILED DESCRIPTION

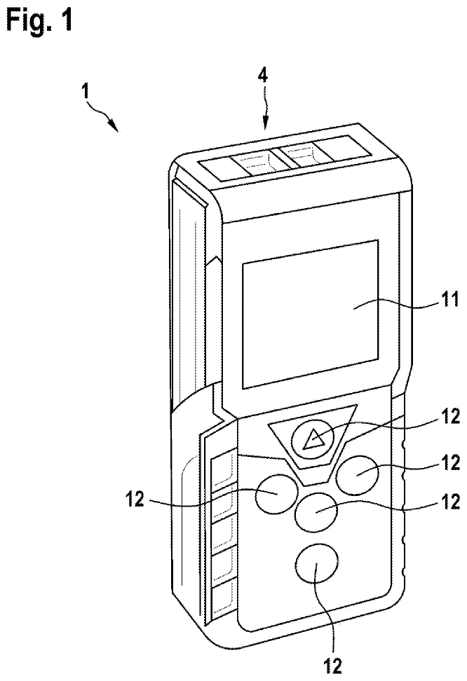

FIG. 1 shows a schematic illustration of a laser distance measuring device 1 according to exemplary embodiments of the disclosure. This comprises a laser diode 4, a display 11 and a plurality of control buttons 12.

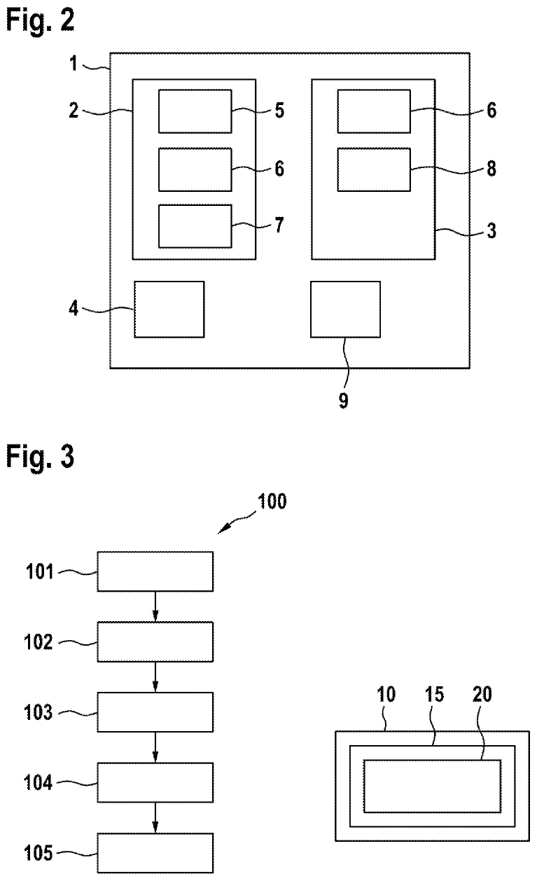

FIG. 2 shows a further schematic illustration of internal equipment of the laser distance measuring device 1 according to exemplary embodiments of the disclosure. This includes a software control loop 2 and a hardware control loop 3. In the software control loop 2, an analog-to-digital converter 5, a processor 6 and a digital-to-analog converter 7 are provided. In the hardware control loop 3, a or the processor 6 and an application-specific integrated circuit 8 are provided. Furthermore, the laser distance measuring device 1 comprises a laser diode 4 and a detector 9.

In particular, the laser distance measuring device 1 according to the disclosure uses an indirect time of flight (iToF) measurement. For example, the laser distance measuring device 1 operates by measuring a phase shift of a modulated light signal emitted by the laser distance measuring device 1 and reflected by a target object. The following is a description of how the Indirect Time of Flight (iToF) measurement works. First, the laser diode 4 in the laser rangefinder 1 can transmit intensity-modulated light, for example in the infrared or visible area, towards a target object. The modulation is in particular carried out with a sinusoidal or square wave. The intensity-modulated light subsequently strikes the target object and is reflected back to the laser rangefinder 1. The detector 9 in the laser distance measuring device 1 can now receive the reflected light. Since the light takes a certain amount of time to travel the distance, there is a phase shift between the transmitted signal and the received signal. This phase shift between the transmitted signal and the received signal may then be measured. This phase shift is in particular proportional to the distance of the light traveled. The distance may then be calculated from the phase shift taking into account the wavelength of the modulation and the speed of light. It may further be provided that a reference phase is determined with a second detector having a constant distance (not shown) to determine the phase shift based on a comparison to the reference phase.

The software control loop 2 and/or the hardware control loop 3 provide, in particular, laser control, i.e., for example, control of the laser diode 4 and/or data transmission. According to the disclosure, the processor 6 is intended in particular for executing software, in particular the algorithms for laser control and safety. A main task of the application-specific integrated circuit 8 is in particular modulation and phase measurement of the laser light. An optional secondary task may be to provide an analog interface for laser power regulation (via ADC and DAC).

Thus, an emission from the laser diode 4 may be controlled by regulating the switching on and off of a laser beam of the laser diode 4 as well as regulating the intensity thereof. This can ensure that the laser beam is transmitted at the correct power and with the correct characteristics.

Upon receipt by the detector 9 of a fraction of the transmitted laser light, the received signal may be processed. This includes, for example, amplification, filtering and conversion of the received analog signal into a digital signal for further analysis, in particular by an analog-digital converter 5.

Furthermore, according to exemplary embodiments of the disclosure, the phase shift between the transmitted signal and the received signal may be measured and optionally compared to the reference phase.

The analog-digital converter 5 preferably converts analog signals received from the detector 9 into digital signals, in particular a laser intensity as a digital word. In particular, these signals represent an intensity of light transmitted by the laser diode 4. The digital signals provided by the respective analog-digital converter 5 may be further filtered, amplified, and processed to reduce noise and improve signal quality.

A digital-analog converter 7 in the laser system 1, or laser distance measuring device, in particular, has the task of converting digital control signals into analog signals. These analog signals can be used to precisely control various components of the laser distance measuring device 1, in particular the laser diode 4. The digital-analog converter 7 preferably generates analog voltages or currents needed to operate the laser diode 4. This control is critical to the emission of the laser beam with the desired intensity. Furthermore, the digital-to-analog converter 7 may convert digital feedback from the processor 6 to analog control signals to continuously adjust the power and stability of the laser diode 4.

The processor 6 preferably generates digital signals based on requirements of the measurement process and feedback from sensors and other components. These digital signals are in particular sent to the digital-analog converter 7. The digital-analog converter 7 preferably converts the received digital signals into analog voltages or currents. These analog signals may then be used to control the laser diode 4.

FIG. 3 schematically illustrates a method 100, a device 10, a storage medium 15, and a computer program 20 according to exemplary embodiments of the disclosure.

FIG. 3 shows in particular an exemplary embodiment for a method for checking a control value in the context of controlling a technical system 1. In a first step 101, the control value is provided by a first component of the technical system 1. In a second step 102, a first checksum is calculated by the first component based on the control value. In a third step 103, the control value and the first checksum are transmitted to a second component of the technical system 1. In a fourth step 104, a second checksum is calculated by the second component based on the transmitted control value. In a fifth step 105, the control value is checked by the second component based on a comparison of the first checksum with the second checksum.

With the method according to the disclosure, the data transmission of safety-relevant values can be further secured against errors and/or manipulation in order to increase functional safety.

For this purpose, the control values, in particular measured and actuating variables, are preferably provided with a checksum (CRC) prior to transmission from the transmitter, i.e., from the first component. If the checksum does not match the payload received by the receiver, i.e., by the second component, the receiver preferably places the technical system 1, in particular the laser diode 4 of the laser distance measuring device 1, into a safe state. Thus, for example, the probability of a safety-critical transmission error is reduced by a factor of 2 to the power of the bit length (NCRC) of the checksum (MTTFd×2NCRC).

In the software control loop 2, the method according to exemplary embodiments of the disclosure could proceed as follows. For example, the analog-to-digital converter 5 calculates a checksum for the transmitted measured value. The processor 6 can check this checksum. If it does not match, the processor 6 preferably discontinues the control and switches off the laser diode 4. The control then preferably calculates a new digital-to-analog converter actuating value from the analog-to-digital converter measured value. The processor 6 now preferably calculates a checksum for the transmitted actuating value. The digital-to-analog converter 7 can now check this checksum. If it does not match, the digital-to-analog converter 7 preferably goes into a safe state, i.e., the laser diode 4 is preferably switched off. Furthermore, an output may be initiated to indicate an error.

In the hardware control loop 3, the method according to exemplary embodiments of the disclosure could proceed as follows. In particular, the processor 6 calculates a checksum for the target value of the control. The application-specific integrated circuit 8 now preferably checks this checksum. If it does not match, the control is discontinued, for example, and the laser diode 4 is switched off. Furthermore, an output may be initiated to indicate an error.

The foregoing explanation of the exemplary embodiments describes the present disclosure exclusively in the context of examples. Of course, individual features of the embodiments can be freely combined with one another, if technically feasible, without leaving the scope of the present disclosure.

What is claimed is:

1. A method for checking a control value as part of controlling a technical system, comprising:
providing the control value by way of a first component of the technical system;
calculating a first checksum based on the control value provided by the first component;
transmitting the control value and the first checksum to a second component of the technical system;
calculating a second checksum based on the control value transmitted by the first component; and
checking the control value based on a comparison of the first checksum with the second checksum by the second component.

2. The method according to claim 1, wherein the technical system is a laser distance measuring device and comprises at least one software control loop and/or a hardware control loop, and wherein a laser diode of the laser distance measuring device is controlled as part of controlling the software control loop and/or the hardware control loop.

3. The method according to claim 2, wherein the software control loop comprises an analog-to-digital converter and a processor, wherein the first component is the analog-to-digital converter and the second component is the processor, and wherein the control value corresponds to a measured value of the laser diode.

4. The method according to claim 2, wherein:
the software control loop comprises a digital-to-analog converter and a processor, wherein the first component is the processor, and the second component is the digital-to-analog converter, and wherein the control value corresponds to an actuating value for the laser diode, or
the method further comprises:
providing an actuating value for the laser diode by way of the processor,
calculating a third checksum based on the actuating value by way of the processor,
transmitting the actuating value and the third checksum to the digital-to-analog converter,
calculating a fourth checksum based on the transmitted actuating value by way of the digital-to-analog converter,
checking the actuating value based on a comparison of the third checksum with the fourth checksum by way of the digital-to-analog converter.

5. The method according to claim 2, wherein:
the hardware control loop comprises a processor and an application-specific integrated circuit, wherein the first component is the processor, and the second component is the application-specific integrated circuit, and wherein the control value corresponds to a target value for the laser diode, or
the method further comprises:
providing a target value for the laser diode by way of the processor,
calculating a fifth checksum based on the target value by way of the processor,
transmitting the target value and the fifth checksum to the application-specific integrated circuit,
calculating a sixth checksum based on the transmitted target value by way of the application-specific integrated circuit,
checking the target value based on a comparison of the fifth checksum with the sixth checksum by way of the application-specific integrated circuit.

6. The method according to claim 1, wherein the method, if checking the control value indicates an inequality between the first checksum and the second checksum and/or checking the actuating value indicates an inequality between the third checksum and the fourth checksum and/or if checking the target value indicates an inequality between the fifth checksum and the sixth checksum, further comprises:
transitioning the technical system to a safe state.

7. The method according to claim 1, wherein the method, if checking the control value indicates an inequality between the first checksum and the second checksum and/or checking the actuating value indicates an inequality between the third checksum and the fourth checksum and/or if checking the target value indicates an inequality between the fifth checksum and the sixth checksum, further comprises:
initiating an output, wherein the output indicates that there is an error in the technical system or the control of the technical system.

8. A computer program, comprising commands which, when the computer program is executed by at least one computer, cause the latter to execute the method according to claim 1.

9. A laser distance measuring device comprising a software control loop and/or a hardware control loop, wherein the laser distance measuring device is configured to perform the method according to claim 2.

10. A computer-readable storage medium comprising instructions which, when executed by at least one computer, prompt the computer to perform the steps of the method according to claim 1.

11. The method according to claim 1, wherein the method, if checking the control value indicates an inequality between the first checksum and the second checksum and/or checking the actuating value indicates an inequality between the third checksum and the fourth checksum and/or if checking the target value indicates an inequality between the fifth checksum and the sixth checksum, further comprises:
transitioning the laser diode of the laser distance measuring device to an off state.
